(19) United States
(12) Patent Application Publication
(10) Pub. No.: US 2014/0334387 A1
(43) Pub. Date: Nov. 13, 2014

(54) METHOD, APPARATUS, AND COMPUTER PROGRAM PRODUCT FOR PROTECTING SHARED TRANSMISSION OPPORTUNITY

(71) Applicant: NOKIA CORPORATION, Espoo (FI)

(72) Inventors: Klaus DOPPLER, Albany, CA (US); Sayantan CHOUDHURY, Berkeley, CA (US); Esa TUOMAALA, Berkeley, CA (US); Chittabrata GHOSH, Freemont, CA (US)

(73) Assignee: Nokia Corporation, Espoo (FI)

(21) Appl. No.: 13/889,475

(22) Filed: May 8, 2013

(51) Int. Cl. H04L 5/00; H04W 72/04

(52) U.S. Cl. CPC H04L 5/0053; H04W 72/0446
USPC 370/329

(57) ABSTRACT

Embodiments of the invention provide signaling mechanisms for wireless networks composed of a large number of stations. An example method embodiment comprises: receiving, by a first apparatus, a request-to-send frame for a transmission opportunity from a second apparatus; transmitting, by the first apparatus, a first clear-to-send frame for a shared transmission opportunity to the second apparatus; receiving, by the first apparatus, a second clear-to-send frame as response to the first clear-to-send frame from a third apparatus; receiving a data frame from the second apparatus during the shared transmission opportunity; and forwarding the data frame to the third apparatus during the same shared transmission opportunity.

### FIELD

The field of technology relates to wireless communication and more particularly to signaling mechanisms for wireless networks composed of a large number of stations.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long range communication networks, like GSM, are a well-accepted means for transmitting and receiving data, due to cost, traffic and legislative concerns, these networks may not be appropriate for all data applications.

Short range communication technologies provide communication solutions that avoid some of the problems seen in large cellular networks. Bluetooth™ is an example of a short range wireless technology quickly gaining acceptance in the marketplace. In addition to Bluetooth™ other popular short range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for wireless networks composed of a large number of stations.

An example embodiment of the invention includes a method comprising:

receiving, by a first apparatus, a request-to-send frame for a transmission opportunity from a second apparatus;

transmitting, by the first apparatus, a first clear-to-send frame for a shared transmission opportunity to the second apparatus;

receiving, by the first apparatus, a second clear-to-send frame as response to the first clear-to-send frame from a third apparatus;

receiving a data frame from the second apparatus during the shared transmission opportunity; and forwarding the data frame to the third apparatus during the same shared transmission opportunity.

An example embodiment of the invention includes a method comprising:

wherein a bit in the first clear-to-send frame indicates an intention to share the transmission opportunity.

An example embodiment of the invention includes a method comprising:

wherein the first clear-to-send frame comprises a first duration field value and the second clear-to-send frame comprises a second duration field value that is based on the first duration field value.

An example embodiment of the invention includes a method comprising:

wherein the second clear-to-send frame comprises at least one of a copy of a receiver address in the first clear-to-send frame and at least a portion of a basic service set identifier of the first apparatus.

An example embodiment of the invention includes a method comprising:

wherein the first apparatus and the second apparatus are in a sub-network and the third apparatus is an access point in a basic service set network that is overlapped by the sub-network, and the first apparatus serves as a relay between the second apparatus and the third apparatus.

An example embodiment of the invention includes a method comprising:

wherein the sub-network is at least one of part of the basic service set network that is a long-range IEEE 802.11 ah network and a short-range wireless network that overlaps the basic service set network that is a long-range IEEE 802.11ah network.

An example embodiment of the invention includes a method comprising:

determining by the first apparatus, that the request-to-send frame indicates a proposed transmission opportunity time interval that is not long enough to complete a data transmission to the third apparatus; and

transmitting, by the first apparatus, in response to the determination, the first clear-to-send frame, including an indication of the shared transmission opportunity with a longer time interval needed to forward data from the first apparatus to the third apparatus.

An example embodiment of the invention includes an apparatus comprising:

at least one processor;

at least one memory including computer program code;

the at least one memory and the computer program code configured to, with the at least one processor, cause the apparatus at least to:

receive a request-to-send frame for a transmission opportunity from a second apparatus;

transmit a first clear-to-send frame for a shared transmission opportunity to the second apparatus;

receive a second clear-to-send frame as response to the first clear-to-send frame from a third apparatus;

receive a data frame from the second apparatus during the shared transmission opportunity; and

forward the data frame to the third apparatus during the same shared transmission opportunity.

An example embodiment of the invention includes an apparatus comprising:

wherein a bit in the first clear-to-send frame indicates an intention to share the transmission opportunity.

An example embodiment of the invention includes an apparatus comprising:

wherein the first clear-to-send frame comprises a first duration field value and the second clear-to-send frame comprises a second duration field value that is based on the first duration field value.

An example embodiment of the invention includes an apparatus comprising:

wherein the second clear-to-send frame comprises at least one of a copy of a receiver address in the first clear-to-send frame and at least a portion of a basic service set identifier of the apparatus.

An example embodiment of the invention includes an apparatus comprising:

wherein the apparatus and the second apparatus are in a sub-network and the third apparatus is an access point in a basic service set network that is overlapped by the sub-network, and the apparatus serves as a relay between the second apparatus and the third apparatus.

An example embodiment of the invention includes an apparatus comprising:

wherein the sub-network is at least one of part of the basic service set network that is a long-range IEEE 802.11 ah network and a short-range wireless network that overlaps the basic service set network that is a long-range IEEE 802.11ah network.

An example embodiment of the invention includes an apparatus comprising:

the at least one memory and the computer program code configured to, with the at least one processor, cause the apparatus at least to:

determine that the request-to-send frame indicates a proposed transmission opportunity time interval that is not long enough to complete a data transmission to the third apparatus; and

transmit, in response to the determination, the first clear-to-send frame, including an indication of the shared transmission opportunity with a longer time interval needed to forward data from the first apparatus to the third apparatus.

An example embodiment of the invention includes a computer program product comprising computer executable program code recorded on a computer readable, non-transitory storage medium, the computer executable program code comprising:

code for receiving, by a first apparatus, a request-to-send frame for a transmission opportunity from a second apparatus;

code for transmitting, by the first apparatus, a first clear-to-send frame for a shared transmission opportunity to the second apparatus;

code for receiving, by the first apparatus, a second clear-to-send frame as response to the first clear-to-send frame from a third apparatus;

code for receiving a data frame from the second apparatus during the shared transmission opportunity; and

code for forwarding the data frame to the third apparatus during the same shared transmission opportunity.

An example embodiment of the invention includes a computer program product comprising

wherein a bit in the first clear-to-send frame indicates an intention to share the transmission opportunity.

An example embodiment of the invention includes a computer program product comprising

wherein the first clear-to-send frame comprises a first duration field value and the second clear-to-send frame comprises a second duration field value that is based on the first duration field value.

An example embodiment of the invention includes a method comprising:

transmitting, by a second apparatus, a request-to-send frame for a transmission opportunity;

receiving, by the second apparatus, a first clear-to-send frame for a shared transmission opportunity from a first apparatus;

receiving, by the second apparatus, a second clear-to-send frame as response to the first clear-to-send frame from a third apparatus; and

transmitting, by the second apparatus, a data frame to the first apparatus during the shared transmission opportunity, for forwarding by the first apparatus to the third apparatus during the same shared transmission opportunity.

An example embodiment of the invention includes an apparatus comprising:

at least one processor;

at least one memory including computer program code;

the at least one memory and the computer program code configured to, with the at least one processor, cause the apparatus at least to:

transmit a request-to-send frame for a transmission opportunity;

receive a first clear-to-send frame for a shared transmission opportunity from a first apparatus;

receive a second clear-to-send frame as response to the first clear-to-send frame from a third apparatus; and

transmit a data frame to the first apparatus during the shared transmission opportunity, for forwarding by the first apparatus to the third apparatus during the same shared transmission opportunity.

An example embodiment of the invention includes a method comprising:

receiving, by a third apparatus, a first clear-to-send frame from a first apparatus, in response to a request-to-send frame sent from a second apparatus, the first clear-to-send frame for a shared transmission opportunity for a first link between the first apparatus and the second apparatus and a second link between the second apparatus and the third apparatus;

transmitting, by the third apparatus, to the first apparatus, a second clear-to-send frame as response to the first clear-to-send frame; and

receiving, by the third apparatus, a data frame from the second apparatus during the shared transmission opportunity, the data frame having been forwarded by the first apparatus from the second apparatus during the same shared transmission opportunity.

An example embodiment of the invention includes an apparatus comprising:

at least one processor;

at least one memory including computer program code;

the at least one memory and the computer program code configured to, with the at least one processor, cause the apparatus at least to:

receive a first clear-to-send frame from a first apparatus, in response to a request-to-send frame sent from a second apparatus, the first clear-to-send frame for a shared transmission opportunity for a first link between the first apparatus and the second apparatus and a second link between the second apparatus and the apparatus;

transmit to the first apparatus, a second clear-to-send frame as response to the first clear-to-send frame; and

receive a data frame from the second apparatus during the shared transmission opportunity, the data frame having been forwarded by the first apparatus from the second apparatus during the same shared transmission opportunity.

The resulting example embodiments provide signaling mechanisms for wireless networks composed of a large number of stations.

### DESCRIPTION OF THE FIGURES

FIG. 1A is an example network diagram of a long-range IEEE 802.11ah network BSS 1 and two wireless networks, Sub-Network 2 and Sub-Network 3, that overlap the long-range network BSS 1. Each Sub-Network 2 and Sub-Network 3 includes a relay station to relay messages uplink from stations in the sub-network to the access point in the long-range network. A station in one of the sub-networks, Sub-Network 2, is shown transmitting a request-to-send (RTS) frame to the relay station in its network, for relaying an indication that the originating station wishes to transmit data uplink to the long-range access point, according to an example embodiment of the invention. Stations in the long-range network BSS 1 and Sub-Network 2 and Sub-Network 3 that are able to receive the RTS frame, may delay their uplink transmissions by at least a NAV delay interval specified in the RTS frame.

FIG. 1B is the example network diagram of FIG. 1A, wherein the relay station transmits back to the originating station, in response to the RTS frame, a first clear-to-send (CTS1) frame that includes a TXOP share bit that indicates an intention to share the transmission opportunity (TXOP). The originating station then delays its uplink transmission of data by at least a NAV delay interval specified in the CTS1 frame. The long-range access point also receives the clear-to-send frame CTS1, according to an example embodiment of the invention. Stations in the long-range network BSS 1 and Sub-Network 2 and Sub-Network 3 that are able to receive the CTS 1 frame, may delay their uplink transmissions by at least a NAV delay interval specified in the CTS1 frame.

FIG. 1C is the example network diagram of FIG. 1B, wherein the long-range access point recognizes the relay station that sent the CTS 1 frame. The access point may also recognize the receiver address of the station in the first CTS. It knows that the station is associated with the relay station. In response to the TXOP share bit in the CTS 1 frame, the long-range access point replies by transmitting a second clear-to-send (CTS2) frame that repeats the TXOP share bit indicating an intention to share the transmission opportunity with the originating station. The CTS2 frame may also include the address of the relay station or it may repeat the receiver address of the station in the first CTS1. Stations in the long-range network BSS 1 and Sub-Network 2 and Sub-Network 3 that are able to receive the CTS2 frame, may delay their uplink transmissions by at least a NAV delay interval specified in the CTS2 frame. This will allow the relay station to relay uplink transmissions to the long-range access point, from the originating station, without interference from other stations in the networks, according to an example embodiment of the invention.

FIG. 1D is the example network diagram of FIG. 1C, wherein the originating station in the Sub-Network 2, delays its transmission of a data frame to the relay station in its network, to give the long-range access point time to transmit the second CTS. The originating station is shown transmitting a data frame to the relay station in the first portion of the shared TXOP, according to an example embodiment of the invention.

FIG. 1E is the example network diagram of FIG. 1D, wherein the relay station transmits data frame to the long-range access point in the second portion of the shared TXOP, according to an example embodiment of the invention.

FIG. 2 is an example timing diagram illustrating the stages of TXOP sharing by the originating station and the relay station, as depicted in FIGS. 1A to 1E. The RTS, CTS1, CTS2, and data frames are shown in conjunction with the TXOP interval and the NAV intervals specified in the RTS, CTS1, CTS2 frames, according to an example embodiment of the invention.

FIG. 3 is an example RTS frame, according to an example embodiment of the invention.

FIG. 4 is an example first clear-to-send (CTS1) frame transmitted by the relay station, and the control field subfield values within the control frame, according to an example embodiment of the invention.

FIG. 5 is an example table describing the fields in the first clear-to-send (CTS1) frame in the IEEE 802.11ah format, with the addition of the share bit that indicates an intention to share the transmission opportunity (TXOP), according to an example embodiment of the invention.

FIG. 6A is an example flow diagram of operational steps in the wireless relay device, according to an example embodiment of the invention.

FIG. 6B is an example flow diagram of operational steps in the originating station, according to an example embodiment of the invention.

FIG. 6C is an example flow diagram of operational steps in the long-range access point, according to an example embodiment of the invention.

FIG. 7 is an example functional block diagram, illustrating an example wireless relay device, according to an example embodiment of the invention.

FIG. 8 illustrates an example embodiment of the invention, wherein examples of removable storage media are shown, in accordance with at least one embodiment of the present invention.

### DISCUSSION OF EXAMPLE EMBODIMENTS OF THE INVENTION

This section is organized into the following topics:

A. WLAN Communication Technology

B. PROTECTING SHARED TRANSMISSION OPPORTUNITY

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request-to-send (RTS) and the receiver may respond with a Clear-to-send (CTS). The channel may be cleared by these two messages, since all other STAs that hear at least one of the CTS and the CTS may suppress their own start of a transmission. The Request-to-send (RTS) packet sent by the sender and the Clear-to-send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear-to-send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the terminal devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the terminal device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TBTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the terminal device. There may be no indication to the outside world that a device has joined a particular ad hoc network. Joining an ad hoc network may require that the terminal device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the terminal device has joined the ad hoc network and is ready to begin communicating with the devices in the ad hoc network.

A terminal device may associate or register with an access point to gain access to the network managed by the access point. Association allows the access point to record each terminal device in its network so that frames may be properly delivered. After the terminal device authenticates to the access point, it sends an association request to the access point. Association allows the access point to record each terminal device so that frames may be properly delivered. The association request is a management frame that contains information describing the terminal device, such as its capability, listening interval, SSID, supported rates, power capability, QoS capability, and the like. The access point processes the association request and grants association by replying with an association response frame. The association response frame is a management frame that contains information describing the access point, such as its capability and supported rates. The association response frame also includes an association ID (AID) that is assigned by the access point to identify the terminal device for delivery of buffered frames. The AID field is a value assigned by the access point during association, which represents the 16-bit ID of a terminal device. The length of the AID field is two octets, the value assigned as the AID is in the range 1-2007, and it is placed in the 14 lowest significant bits (LSBs) of the AID field, with the two most significant bits (MSBs) of the AID field each set to “1”.

An access point may maintain a polling list for use in selecting terminal devices in its network, which are eligible to receive contention free polls (CF-Polls) during contention free periods. The polling list is used to force the polling of contention free terminal devices capable of being polled, whether or not the access point has pending traffic to transmit to those terminal devices.

Whenever an access point needs to poll a group of terminal devices who already know their respective AIDs within the network that the access point manages, a contention free (CF) group poll message may be sent by the access point.

After receiving contention free (CF) group poll message from the access point, a terminal device in the group that has data to send, transmits a response message or acknowledgement (ACK) to access point, after waiting for a short interframe space (SIFS) interval.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

A Traffic Indication Map (TIM) is a field transmitted in beacon frames, used to inform associated wireless terminal devices or STAs that the access point has buffered data waiting to be transmitted to them. Access points buffer frames of data for STAs while they are sleeping in a low-power state. The access point transmits beacons at a regular interval, the target beacon transmission time (TBTT). The Traffic Indication Map (TIM) information element in the periodically transmitted beacon frame, indicates which STAs have buffered data waiting to be accessed in the access point. Each frame of buffered data is identified by an association identifier (AID) associated with a specific STAs. The AID is used to logically identify the STAs to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless terminal devices must wake up and listen for the periodic beacon frames to receive the Traffic Indication Map (TIM). By examining the TIM, a STAs may determine if the access point has buffered data waiting for it. To retrieve the buffered data, the STAs may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

The IEEE 802.11ah WLAN standard operating below 1 GHz, has a greater range and lower obstruction losses due to its longer wavelength. IEEE 802.11ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point. Due to the large range and the high number of stations in the network, hidden nodes pose a major problem in the operation of the 802.11ah networks.

The IEEE 802.11ah WLAN standard has support to organize the STAs associated to a network, into groups. The association response frame transmitted by the access point device, may indicates a group ID, along with the conventional association ID (AID) field that associates the STA to the access point. The group IDs may be numbered in descending order of group priority for quality of service (QoS) STAs. The access point may base its group ID number for the case of non-QoS STAs on their respective association times. In this manner, the access point may determine which STAs are members of which group. Based on the association request frame from a new requesting STA, the access point either uses QoS parameters or non-QoS parameters, such as proximity and location in a sector of the access point, to decide to which group the new STA is a member. The corresponding group ID of the group to which the new STA is assigned is then sent by the access point to the STA in response to the association request message. The association response frame indicates the group ID, along with the conventional AID field that associates the STA to the access point.

The IEEE 802.11ah WLAN standard includes Synchronized Distributed Coordination Function (DCF) uplink channel access by STAs. The association response frame transmitted by the access point, defines a restricted access period, referred to as a restricted access window (RAW). Each restricted access window comprises multiple time slots and each time slot is allocated to STAs paged in the traffic indication map (TIM). Uplink data transmissions, such as PS-polling operations, may be facilitated by transmitting the packet in a time slot in an uplink restricted access window. Downlink data transmission may be facilitated by the transmission of data packets in a downlink restricted access window. An example procedure for uplink channel access may include:
An awakened STA that decodes the beacon, sends a PS-Poll packet when its traffic indication map (TIM) bit is set to one;
The STA may determine its channel time slot in an uplink restricted access window based on its AID bit position in the traffic indication map (TIM);
The STA may contend for access to the time slot with other STAs in the same group;
After resolving PS-Polls from STAs, the access point broadcasts a downlink allocation packet that is positioned after the uplink restricted access window and before the downlink restricted access window, which includes a Block ACK, the duration of downlink restricted access window, and/or allocated downlink time slot for the STAs.

The access point includes in its transmitted beacon frame, a Restricted Access Window Parameter Set information element to informs the STAs within a group of [1] the interval they may sleep before they may contend for the medium and [2] their medium access duration. The Restricted Access Window Parameter Set element may include: [1] the range of AID in the group; [2] a prohibition interval; and [3] a group interval end time. The group interval end time, as the name implies, specifies the instant following the start of the beacon, at which the uplink restricted access window terminates, which applies to all STAs in the relevant group. The prohibition interval specifies the interval from the group's end time to its next start time at which members of the group are allowed to contend for the radio medium. The Restricted Access Window Parameter Set information element in the beacon frame enables the access point to place a given STA in one group in one beacon frame and move that STA to another group in the next consecutive beacon frame.

Wi-Fi Direct—Software Access Points

The Wi-Fi Alliance has developed a Wi-Fi Peer-to-Peer technology named Wi-Fi Direct™ that is specified in the Wi-Fi Alliance Peer-to-Peer Specification, October 2010 (incorporated herein by reference). Wi-Fi Direct, is also referred to herein as Peer-to-Peer or P2P. Wi-Fi Direct enables IEEE 802.11a, g, or n devices to connect to one another, peer-to-peer, without prior setup or the need for wireless access points. Wi-Fi Direct embeds a software access point into any device, which provides a version of Wi-Fi Protected Setup. When a device enters the range of a STA supporting Wi-Fi Direct (a Wi-Fi Direct device), it can connect to it and then gather setup information using a Wi-Fi Protected Setup transfer. Devices that support Wi-Fi Direct may discover one another and advertise available services. Wi-Fi Direct devices support typical Wi-Fi ranges and the same data rates as can be achieved with an 802.11a, g, or n infrastructure connection. When a device enters the range of the Wi-Fi Direct device, it may connect to it using the existing protocol, and then gather setup information using a Wi-Fi Protected Setup 2.0 transfer.

Wi-Fi Direct enables IEEE 802.11 devices that support Wi-Fi Direct, to connect to one another, point-to-point, without joining a network. The specification may be implemented in any Wi-Fi device. Devices that support the specification will be able to discover one another and advertise available services. Wi-Fi Direct devices will support typical Wi-Fi ranges and the same data rates as can be achieved with an infrastructure connection. Wi-Fi Direct provides point-to-point connections for networks by embedding a software access point into any device that wishes to support Wi-Fi Direct. The soft AP provides a version of Wi-Fi Protected Setup 1.0 by entering a PIN or pressing a button. When a device enters the range of the Wi-Fi Direct device, it may connect to it using the existing protocol, and then gather setup information using a Wi-Fi Protected Setup 1.0 transfer.

Wi-Fi Direct-certified devices may create direct connections between Wi-Fi client devices without requiring the presence of a traditional Wi-Fi infrastructure network of an access point or router. Wi-Fi Direct-certified devices support connection with existing legacy Wi-Fi devices using the IEEE 802.11a/g/n protocols. Wi-Fi Direct Device Discovery and Service Discovery features allow users to identify available devices and services before establishing a connection, for example, discovering which Wi-Fi networks have a printer. Wi-Fi Direct devices may use Wi-Fi Protected Setup to create connections between devices.

A Wi-Fi Direct device is capable of a peer-to-peer connection and may support either an infrastructure network of an access point or router or a peer-to-peer (P2P) connection. Wi-Fi Direct devices may join infrastructure networks as stations (STAs) and may support Wi-Fi Protected Setup enrollee functionality. Wi-Fi Direct devices may connect by forming Groups in a one-to-one or one-to-many topology. The Groups functions in a manner similar to an infrastructure basic service set (BSS). A single Wi-Fi Direct device will be the Group Owner (GO) that manages the Group, including controlling which devices are allowed to join and when the Group is started or terminated. The Group Owner (GO) will appear as an access point to legacy client's devices.

Wi-Fi Direct devices include a Wi-Fi Protected Setup Internal Registrar functionality and communication between Clients in the Group. Wi-Fi Direct devices may be a Group Owner (GO) of a Group and may be able to negotiate which device Adopts this role when forming a Group with another Wi-Fi Direct device. A Group may include both Wi-Fi Direct devices and legacy devices (i.e., that are not compliant with the Wi-Fi Alliance Peer-to-Peer Specification). Legacy Devices can only function as Clients within a Group.

Wi-Fi Direct devices may support Discovery mechanisms. Device Discovery is used to identify other Wi-Fi Direct devices and establish a connection by using a scan similar to that used to discover infrastructure access points. If the target is not already part of a Group, a new Group may be formed. If the target is already part of a Group, the searching Wi-Fi Direct device may attempt to join the existing Group. Wi-Fi Protected Setup may be used to obtain credentials from the Group Owner (GO) and authenticate the searching Wi-Fi Direct device. Wi-Fi Direct devices may include Service Discovery that enables the advertisement of services supported by higher layer applications to other Wi-Fi Direct devices. Service Discovery may be performed at any time (e.g. even before a connection is formed) with any other discovered Wi-Fi Direct device.

A Group may be created by a single Wi-Fi Direct device, such as when connecting a legacy device. When forming a connection between two Wi-Fi Direct devices, a Group may be formed automatically and the devices may negotiate to determine which device is the Group Owner. The Group Owner may decide if this is a temporary (single instance) or persistent (multiple, recurring use) Group. After a Group is formed, a Wi-Fi Direct device may invite another Wi-Fi Direct device to join the Group. The decision of whether or not to accept an invitation may be left to the invited Wi-Fi Direct device.

Concurrent Wi-Fi Direct Devices may participate in multiple Groups, simultaneously, each group requires own Wi-Fi stack. A Wi-Fi Direct Device that may be in a Group while maintaining a WLAN infrastructure connection at the same time is considered a Concurrent Device or a dual stack device. For example, a laptop connected directly to a printer while simultaneously using a WLAN connection is operating as a Concurrent Device. Concurrent connections may be supported by a single radio and may support connections on different channels. Concurrent operation may be supported by multiple protocol stacks, for example, one for operation as a WLAN-STA and one for operating as a Wi-Fi Direct device. For example, two separate physical MAC entities may be maintained, each associated with its own PHY entity, or they may use a single PHY entity supporting two virtual MAC entities.

The Wi-Fi Peer-to-Peer Technical Specification v1.1, 2010 published by the Wi-Fi Alliance, provides for provisioning in Wi-Fi Direct networks. Provisioning is a phase of peer-to-peer group formation in which credentials for the peer-to-peer group are exchanged based on the use of Wi-Fi Simple Configuration. Credentials are information that is required to join a peer-to-peer group as defined in the Wi-Fi Simple Configuration Specification.

To allow for peer-to-peer device configuration, peer-to-peer devices may delay starting the provisioning phase until the expiration of the larger of the peer-to-peer group owner's (GO) configuration time and the peer-to-peer client's client configuration time, based on respective configuration timeout attributes exchanged during a preceding group owner negotiation.

The peer-to-peer device selected as peer-to-peer group owner (GO) during group owner negotiation may start a peer-to-peer group session using the credentials it intends to use for that group. The peer-to-peer group owner (GO) may use the operating channel indicated during group owner negotiation, if available. The peer-to-peer client may connect to the peer-to-peer group owner to obtain credentials. If the operating channel is not available the peer-to-peer group owner may use another channel from a channel list attribute sent in the group owner negotiation confirmation frame. The peer-to-peer client may have to scan to find the peer-to-peer group owner if the intended operating channel is not available. A group formation bit in a peer-to-peer group capability bitmap of the peer-to-peer capability attribute may be set to one until provisioning succeeds.

Provisioning may be executed in Wi-Fi Direct networks, as described, for example, in the Wi-Fi Simple Configuration (WSC) Specification, Version 2.0, Dec. 20, 2010. The peer-to-peer group owner (GO) may serve the role as the access point with an internal registrar. It will only allow association by the peer-to-peer device that it is currently with in a group formation. Since the user has entered the WSC PIN or triggered the WSC pushbutton functionality on both devices, the registrar may send an M2 message in response to an M1 message. The peer-to-peer client may serve the role as the STA enrollee. It may associate to the peer-to-peer device that it is currently with in the group formation.

If provisioning fails, then group formation ends and the peer-to-peer group owner (GO) may end the peer-to-peer group session. If provisioning fails, the peer-to-peer device may retry group formation or return to device discovery. On successful completion of provisioning in Wi-Fi Direct networks, the peer-to-peer group owner (GO) may set the group formation bit in the peer-to-peer group capability bitmap of the peer-to-peer capability attribute to zero. At this point the peer-to-peer client may join the peer-to-peer group in the Wi-Fi Direct network, using the credentials supplied during provisioning.

B. PROTECTING SHARED TRANSMISSION OPPORTUNITY

In sensor networks and smart grid applications, large numbers of wireless terminals or STAs, both fixed and mobile, arrayed over kilometer-sized areas, will need to communicate with a long range access point device. In the case of IEEE 802.11ah networks, it is envisioned to have a Wi-Fi network of 6000 wireless terminal devices or STAs being served by a long range access point. The STAs may operate on battery power and must conserve their power during long periods of inactivity punctuated by short durations of communication sessions.

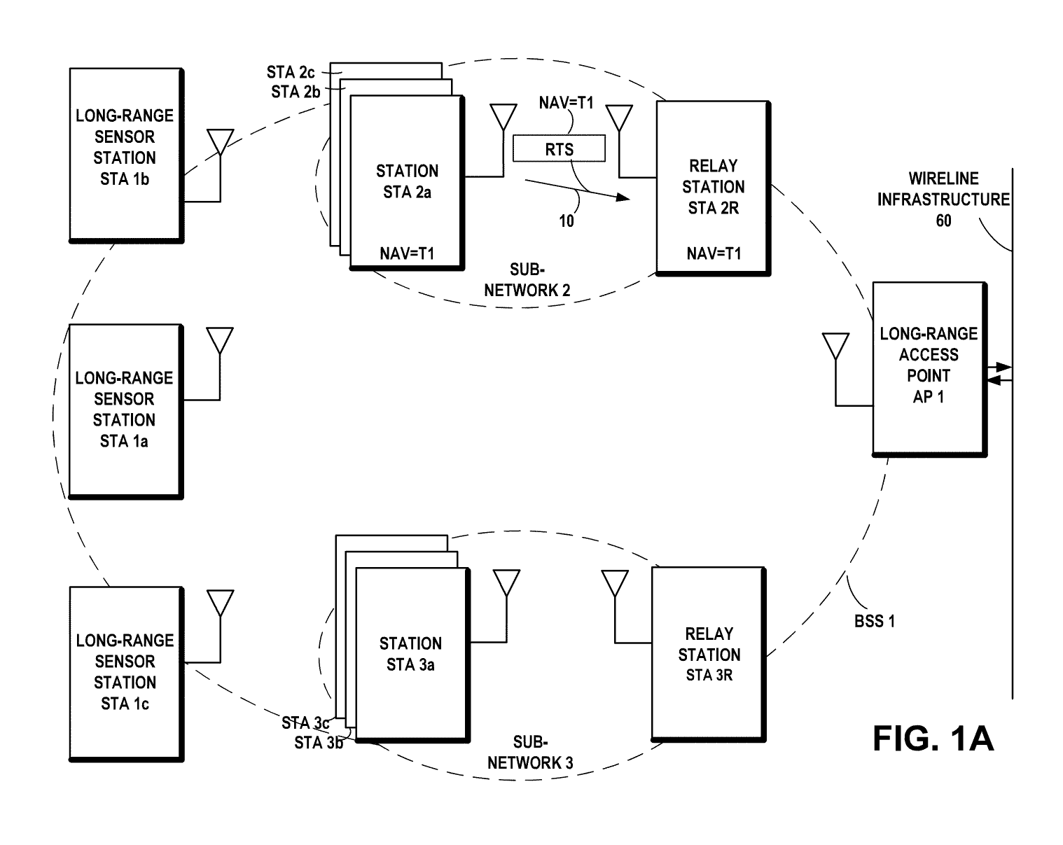

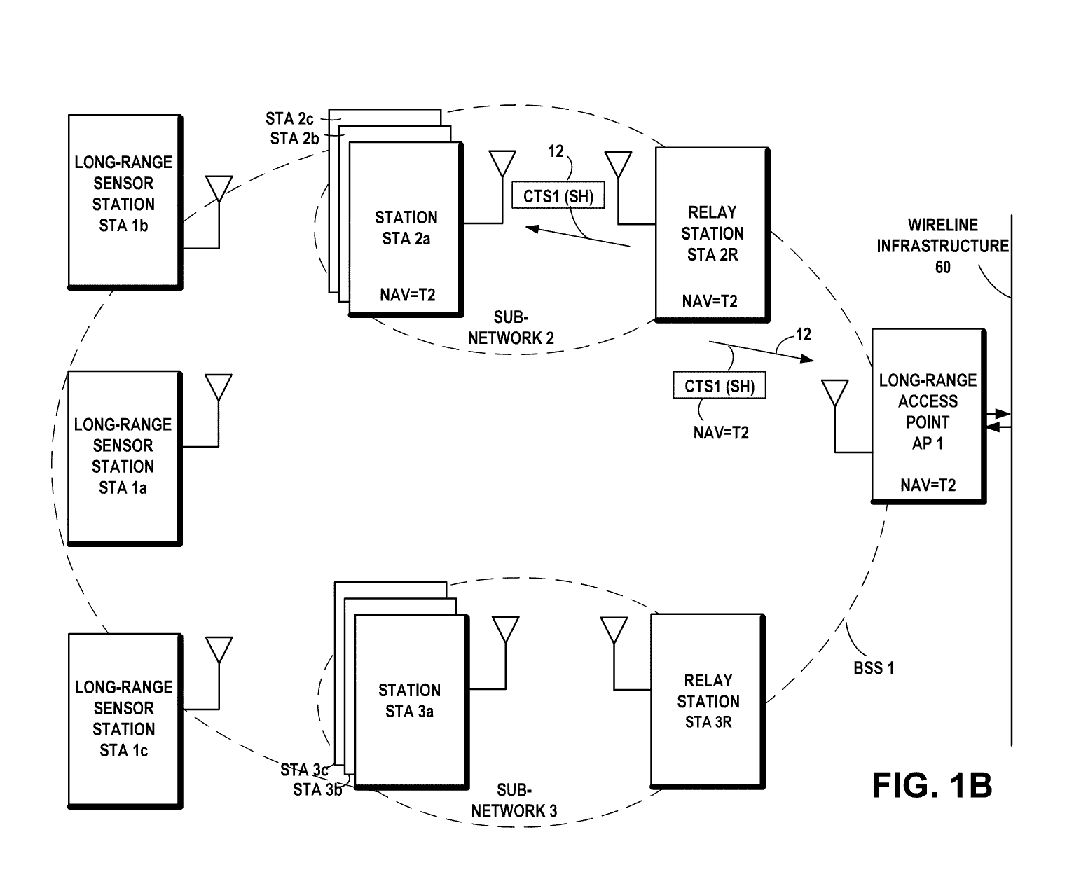

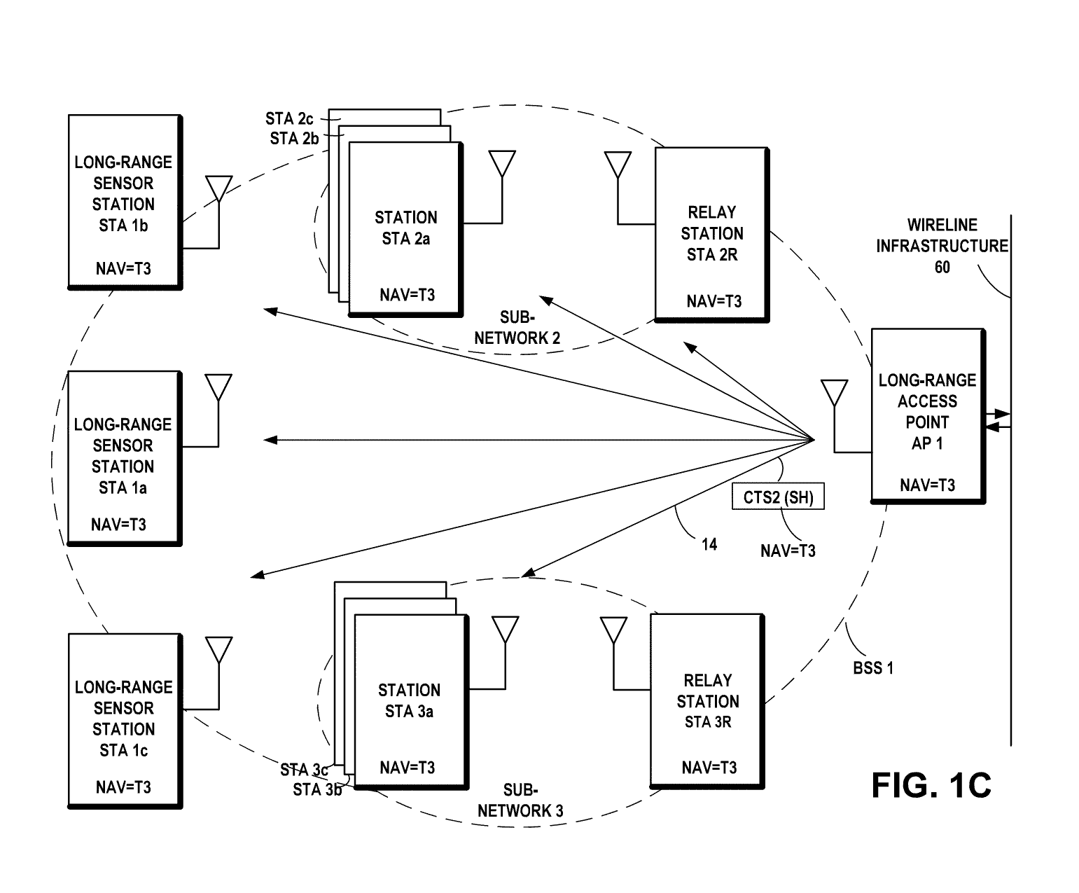

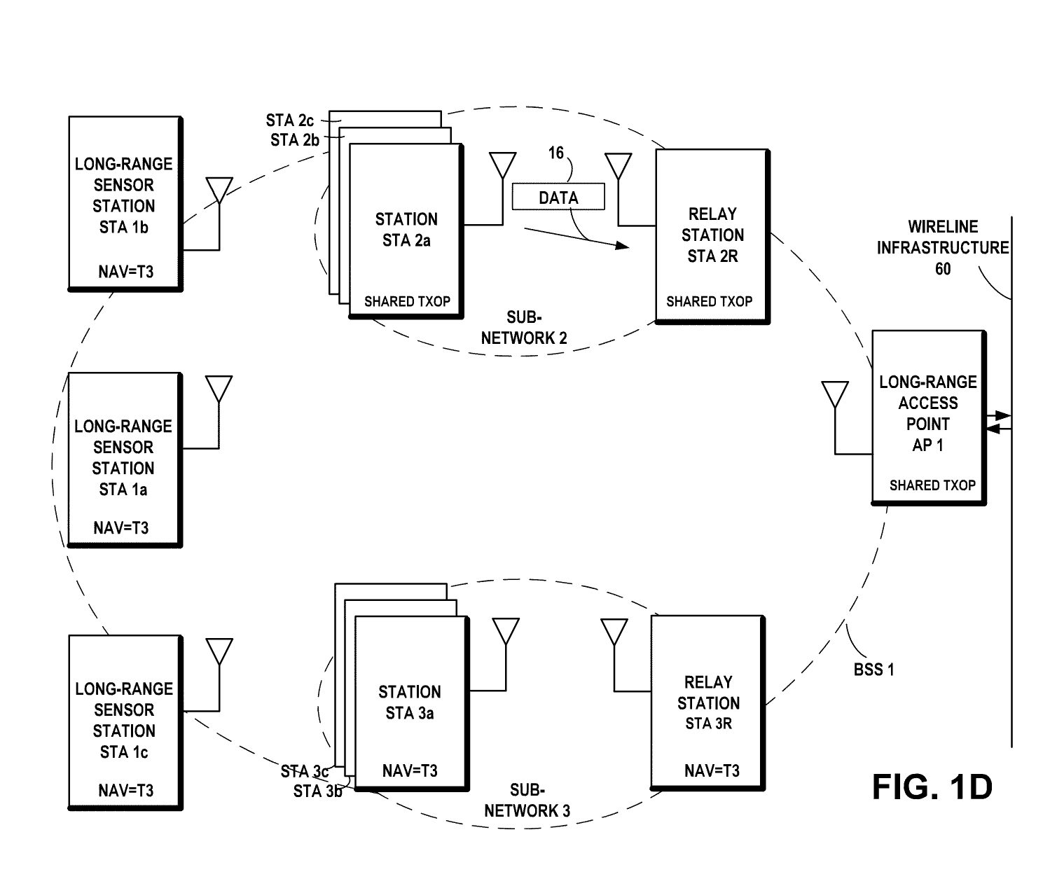

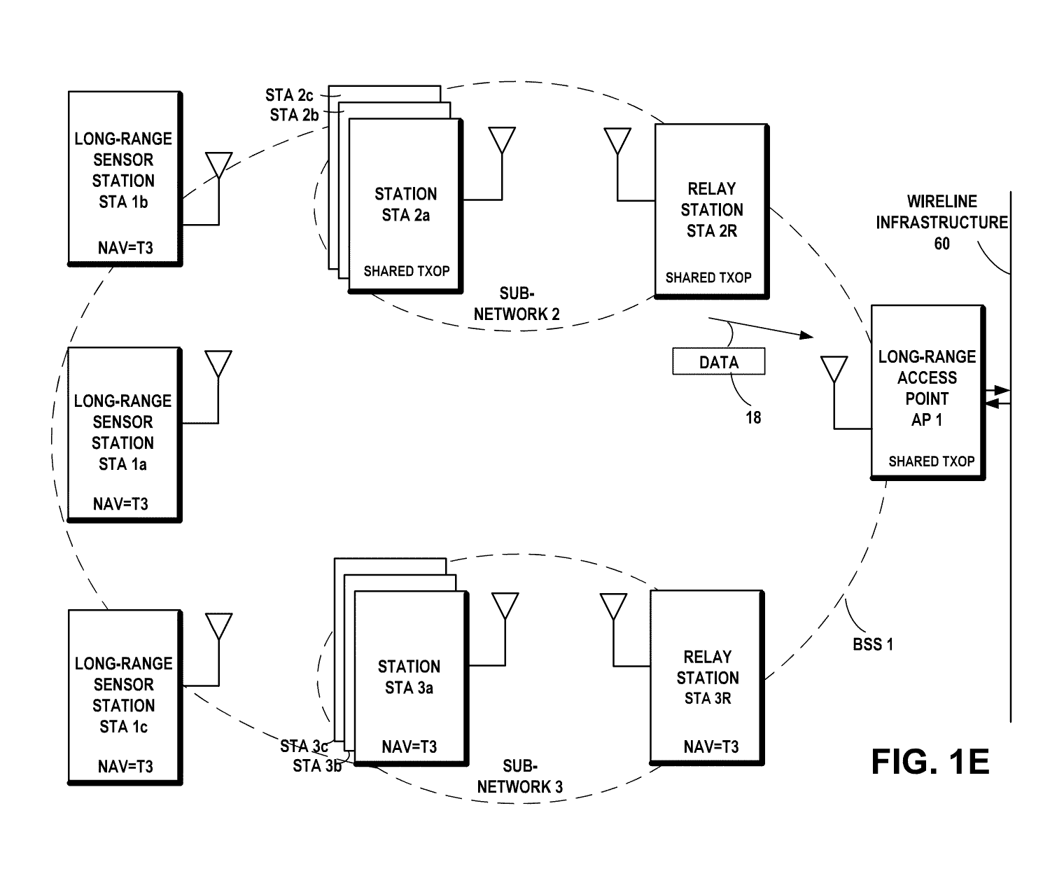

FIG. 1A is an example network diagram of a long-range IEEE 802.11ah network BSS 1 and two wireless networks Sub-Network 2 and Sub-Network 3 that overlap the long-range network BSS 1. Each Sub-Network 2 and Sub-Network 3 includes a respective relay station STA 2R and STA 3R to relay messages uplink from stations in the sub-network to the long-range access point AP 1 in the long-range network BSS 1. The relay stations may also relay messages downlink from the access point AP 1 to stations in the Sub-Network 2 and Sub-Network 3.

In an example embodiment of the invention, the Sub-Network 2 and Sub-Network 3 may be part of the long-range IEEE 802.11ah network BSS 1. Stations STA 2a, STA 2b, and STA 2c, in Sub-Network 2 may use the station STA 2R as a relay station for relaying data to long-range access point AP 1, because stations STA 2a, STA 2b, and STA 2c, may be located too far from the long-range access point AP 1.

In an example alternate embodiment of the invention, the Sub-Network 2 and Sub-Network 3 may be short-range wireless local area networks that overlap the long-range network BSS 1. The stations STA 2a, STA 2b, and STA 2c need not necessarily know that they served by a relay and the relay may form its own long range BSS network.

For example, Sub-Network 2 includes a relay station STA 2R to relay messages uplink from stations STA 2a, STA 2b, and STA 2c, in the Sub-Network 2 to the access point AP 1 in the long-range network BSS1. A station STA 2a in Sub-Network 2 is shown transmitting a request-to-send (RTS) frame 10 to the relay station STA 2R in its network, for relaying an indication that the originating station STA 2a wishes to transmit data uplink to the long-range access point AP 1. The request-to-send (RTS) frame 10, includes a NAV value T1 that indicates the proposed transmission opportunity (TXOP) time interval that the station STA 2a may require, following the RTS frame, to complete an uplink transmission of its data to the long-range access point AP 1. In an example embodiment of the invention, the originating station STA2a may not know that it is located too far from the long-range access point AP 1 to reach the AP 1 in a single hop. Thus, the NAV value T1 may indicate a proposed transmission opportunity (TXOP) time interval that is not long enough to complete the transmission to the AP 1.

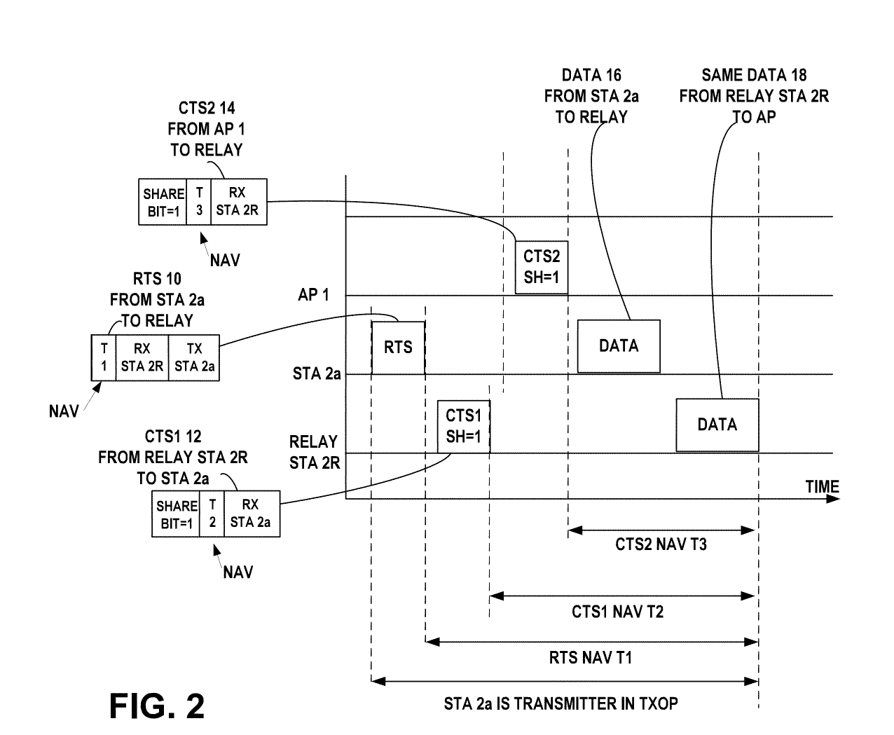

Stations (except the relay station) in the long-range network BSS 1 and Sub-Network 2 and Sub-Network 3 that are able to receive the RTS frame, will delay their uplink transmissions by at least a NAV delay interval specified in the RTS frame. Reference is made to the timing diagram of FIG. 2 that illustrates the NAV value T1 and the proposed transmission opportunity (TXOP) time interval, according to an example embodiment of the invention. The transmission opportunity is the interval during which the wireless medium is reserved for transmission for the link between STA 2a and the long-range access point AP 1, for example. In an example embodiment of the invention, a transmission opportunity is the transmission opportunity according to the IEEE 802.11 specification.

In an example embodiment of the invention, the long range network BSS1 managed by the long-range access point AP 1, may be an IEEE 802.11 ah WLAN that may be applied as a low data rate meter network, e.g., a smart meter pooling data from gas and water meters from various apartments. The stations STA 1a, STA 1b, and STA 1c, in the long-range network BSS 1 and the stations STA2a, STA 2b, STA 2c, STA 3a, STA 3b, and STA 3c in Sub-Network 2 and Sub-Network 3, may typically be wireless sensors that are battery operated and hence power constrained. The long-range access point AP 1 may optionally be connected to a wireline infrastructure 60.

FIG. 1B is the example network diagram of FIG. 1A, wherein the relay station STA 2R receives the request-to-send (RTS) frame 10 from the originating station STA2a and determines that the NAV value T1 indicates a proposed transmission opportunity (TXOP) time interval that may not be long enough to complete the originating station's transmission to the AP 1. In accordance with an example embodiment of the invention, the relay station STA 2R may make this determination based, for example, on the received signal strength of the RTS frame 10 or on variations in uplink network throughput due to factors such as network traffic, interference, variations in the data rate of the AP 1, or other factors. The relay station STA 2R may make the determination based on the past data rate of the STA 2a-to-relay STA 2R link and the past data rate of the relay STA 2R-to-AP link. For example if the STA 2a-to-relay STA 2R link is only half the data rate of the relay STA 2R-to-AP link, the relay station STA 2R would add 50% to the duration. The relay station STA 2R may also use the signal strength of the RTS frame 10 to determine the STA 2a-to-relay STA 2R link quality.

In response to this determination, relay station STA 2R transmits back to the originating station STA 2a, in response to the RTS frame 10, a first clear-to-send (CTS1) frame 12 that includes a TXOP share bit SH that is set equal to one, to indicate an intention by the relay station STA 2R to share the transmission opportunity (TXOP) with the originating station STA 2a. In accordance with an example embodiment of the invention, the relay station STA 2R includes a NAV delay interval T2 in the clear-to-send CTS1 frame 12. In an example embodiment of the invention, the clear-to-send CTS1 frame 12 may comprise a duration field value and the STA receiving the CTS 1 frame may set the NAV according to the duration value. The relay station STA 2R may increase the duration indicated in NAV delay interval T2 in the CTS 1 frame to include the additional interval needed to forward the data packets from the relay station 2R to the access point AP 1. For example, if the data transmission interval is twice as long on the relay-to-access point link as compared to the STA-to-relay link, then the relay station 2R may increase the duration of the NAV delay interval T2 by 50%.

The originating station STA 2a then delays its uplink transmission of data by at least a NAV delay interval T2 specified in the clear-to-send CTS1 frame 12. The long-range access point AP 1 also receives the clear-to-send CTS1 frame 12, according to an example embodiment of the invention. Stations (except the originating station) in the long-range network BSS 1 and Sub-Network 2 and Sub-Network 3 that are able to receive the CTS 1 frame, will delay their uplink transmissions by at least a NAV delay interval specified in the CTS 1 frame. Reference is made to the timing diagram of FIG. 2 that illustrates the NAV value T2 time interval, according to an example embodiment of the invention.

In accordance with an example embodiment of the invention, the shared transmission opportunity is the interval during which the wireless medium is reserved for transmission for a first link between a second apparatus, such as the station STA2a, and a first apparatus, such as the relay station STA 2R, and a second link between the first apparatus, such as the relay station STA 2R and a third apparatus, such as the long-range access point AP 1, for example.

FIG. 1C is the example network diagram of FIG. 1B, wherein the long-range access point AP 1 recognizes the relay station STA 2R that sent the CTS 1 frame. The access point may also recognize the receiver address of the station in the first CTS 1. It knows that the station is associated with the relay station. In accordance with an example embodiment of the invention, the communications link from the relay station STA 2R to the long-range access point AP 1 is protected for the uplink TXOP sharing operation by means of the long-range access point transmitting a second clear-to-send (CTS2) frame 14 in response to receiving the clear-to-send CTS1 frame 12. In response to detecting the TXOP share bit SH=1 in the received CTS1 frame, the long-range access point AP 1 replies by transmitting the second clear-to-send (CTS2) frame 14. The second clear-to-send (CTS2) frame repeats the TXOP share bit SH=1 indicating an intention by the relay station STA 2R to share the transmission opportunity with the originating station STA 2a. The CTS2 frame may also include the address of the relay station and may also repeat the receiver address of the originating STA 2a. Stations STA 1a, STA 1b, and STA 1c, in the long-range network BSS 1 in the stations STA 2b, STA 2c, STA 3a, STA 3bc, and STA 3c in Sub-Network 2 and Sub-Network 3, which are able to receive the CTS2 frame, will delay their respective uplink transmissions by at least a NAV delay interval T3 specified in the CTS2 frame. In an example embodiment of the invention, the clear-to-send CTS2 frame 14 may comprise a duration field value and the STA receiving the CTS2 frame may set the NAV according to the duration value. This will allow the relay station STA 2R to relay uplink transmissions to the long-range access point AP 1, from the originating station STA 2a, without interference from other stations in the networks BSS1, BSS2, and BSS3, according to an example embodiment of the invention. Reference is made to the timing diagram of FIG. 2 that illustrates the NAV value T3 time interval, according to an example embodiment of the invention. In an example embodiment of the invention, the first clear-to-send CTS 1 frame 12 may comprise a first duration field value and the second clear-to-send CTS2 frame 14 may comprise a second duration field value that is based on the first duration field value.

FIG. 1D is the example network diagram of FIG. 1C, wherein the originating station STA 2a in Sub-Network 2, delays its transmission of a data frame 16 to the relay station STA 2R in its network, to give the long-range access point time to transmit the second CTS. The originating station STA 2a is shown transmitting the data frame 16 to the relay station STA 2R in the first portion of the shared TXOP, according to an example embodiment of the invention.

FIG. 1E is the example network diagram of FIG. 1D, wherein the relay station STA 2R relays the data frame 16 as the data frame 18 to the long-range access point AP 1 in the second portion of the shared TXOP, according to an example embodiment of the invention.

FIG. 2 is an example timing diagram illustrating the stages of TXOP sharing by the originating station STA 2a and the relay station STA 2R, as depicted in FIGS. 1A to 1E. The RTS frame 10, CTS1 frame 12, CTS2 frame 14, and the data frames 16 and 18 are shown in conjunction with the TXOP interval and the NAV intervals T1, T2, and T3 respectively specified in the RTS, CTS1, CTS2 frames, according to an example embodiment of the invention.

The IEEE 802.11 enhanced distributed channel access (EDCA) contention access is an extension of the CSMA/CA mechanism to include priorities. The contention window and backoff times in CSMA/CA are adjusted to change the probability of a STA gaining medium access to favor higher priority classes. Each priority is mapped to one of four access categories (AC). Under EDCA, STAs use the same CSMA/CA access mechanism and contend on an equal basis at a given priority. A STA that wins an EDCA contention is granted a transmission opportunity (TXOP), which is the right to use the medium for a period of time. The duration of this TXOP is specified for each access category. A STA may use a TXOP to transmit multiple frames within an access category. If the frame exchange sequence has been completed and there is still time remaining in the TXOP, the STA may extend the frame exchange sequence by transmitting another frame in the same access category. The STA ensures that the transmitted frame and any necessary ACK can fit into the time remaining in the TXOP.

The network allocation vector (NAV) is an indicator of time periods when transmission onto the wireless medium will not be initiated by a STA. STAs receiving a valid frame will update their NAV with the information received in the duration field T for all frames where the new NAV value is greater than the current NAV value, including the RTS and CTS packets, as well data packets. FIG. 2 shows the example RTS packet transmitted by STA2a has a NAV T1 for a duration from the end of the RTS packet to the end of the data packet transmitted by the relay STA 2R uplink to AP 1. STA2a is the transmitter in TXOP. This RTS effectively prevents other STAs within the coverage area of STA2a from transmitting during the TXOP. The CTS packet transmitted by relay STA 2R has a NAV T2 for a duration continuing from the end of the CTS1 packet 12 to the end of the data packet transmitted by the relay STA 2R uplink to AP 1. This CTS 1 effectively prevents other STAs within the coverage area of the relay STA 2R from transmitting during the TXOP. In accordance with an example embodiment of the invention, the relay station STA 2R may increases the duration indicated in NAV delay interval T2 in the CTS 1 frame to include the additional interval needed to forward the data packets from the relay station 2R to the access point AP 1. For example, if the data transmission interval is twice as long on the relay-to-access point link as compared to the STA-to-relay link, then the relay station 2R may increase the duration of the NAV delay interval T2 by 50%. The CTS2 frame 14 transmitted by the AP 1 has a NAV T3 for a duration continuing from the end of the CTS2 frame 14 to the end of the data packet transmitted by the relay STA 2R uplink to AP 1.

Stations STA 1a, STA 1b, and STA 1c, in the long-range network BSS 1 in the stations STA 2b, STA 2c, STA 3a, STA 3bc, and STA 3c in Sub-Network 2 and Sub-Network 3, which are able to receive the CTS2 frame, will delay their respective uplink transmissions by at least a NAV delay interval T3 specified in the CTS2 frame. This will allow the relay station STA 2R to relay uplink transmissions to the long-range access point AP 1, from the originating station STA 2a, without interference from other stations in the networks BSS1, BSS2, and BSS3, according to an example embodiment of the invention.

In accordance with an example embodiment of the invention, both hops may be protected in the shared TXOP of the originating station STA 2a-to-Relay STA 2R link and Relay STA 2R-to-AP 1 link. The shared TXOP protection has the following assumptions:
RTS-CTS may be used to protect both hops to prevent hidden nodes from sending packets that may eventually collide.
If only the originating station STA 2a-to-Relay STA 2R hop is available, single hop transmission may be used, i.e. Relay STA 2R buffers data from originating station STA 2a and forwards it outside of shared TXOP.

In accordance with an example embodiment of the invention, the originating station STA 2a sends an RTS and the Relay STA 2R responds with a CTS (CTS1) indicating TXOP sharing.

The AP 1 responds with a CTS (CTS2) for the Relay STA 2R to AP 1 link

In accordance with an example embodiment of the invention, the relay STA 2R needs to indicate in the CTS message (CTS1) that it wants to share the TXOP. Hence the originating station STA 2a delays the data transmission by SIFS+CTS. The AP 1 needs to know at least one of the following: that the CTS (CTS1) was sent by the relay STA 2R and that the TXOP sharing bit is set. Based on this information the AP 1 will send a CTS (CTS2) to protect the relay STA 2R-AP 1 link. The AP can determine that the CTS1 is from one of the relays in its network from either the partial BSSID of the relay or the Receiver Address that specifies a STA that is associated to the relay STA 2R. The AP knows the STA associated to the relay STA in order to be able to accordingly forward the data packets.

In accordance with an example embodiment of the invention, 802.11ah specifies two options for RTS/CTS message exchange. The RTS/CTS may protect a single frame or multiple frames within a TXOP.

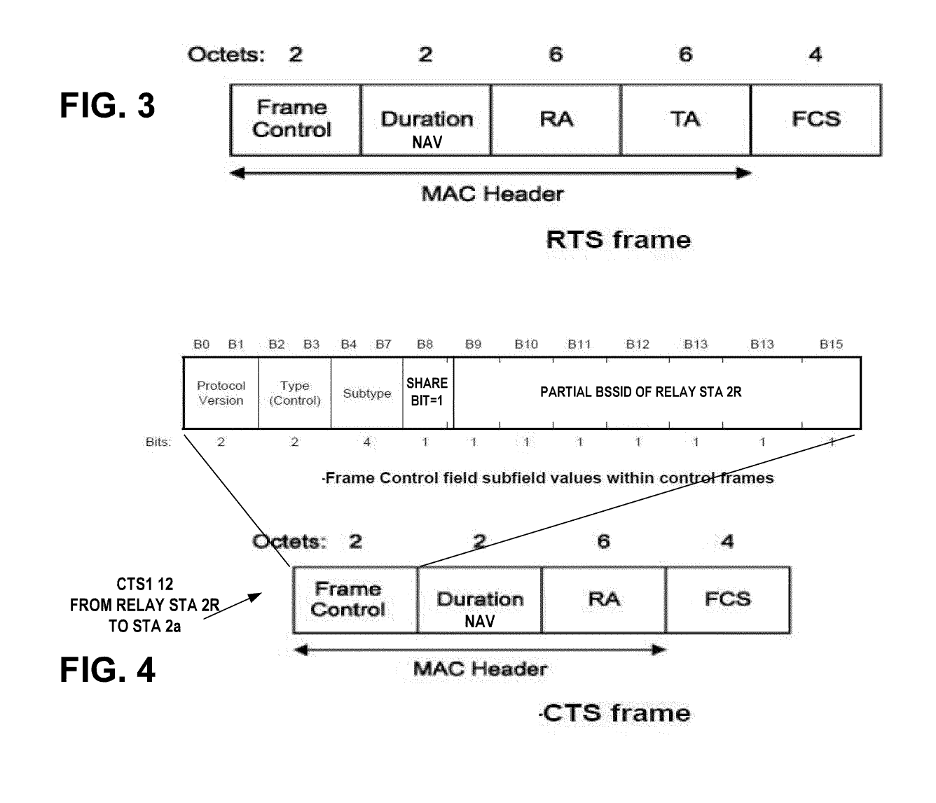

FIG. 3 is an example RTS frame, according to an example embodiment of the invention. The NAV protection period is set in the Duration/ID field of the RTS frame illustrated in FIG. 3.

FIG. 4 is an example first clear-to-send (CTS1) frame transmitted by the relay station, and the control field subfield values within the control frame, according to an example embodiment of the invention. In accordance with an example embodiment of the invention, a bit is used in the Frame Control field to indicate the TXOP sharing with two options:

1. Use a bit in Frame Control field to indicate the TXOP sharing

2. New TXOP sharing CTS subtype

In accordance with an example embodiment of the invention, a new Subtype (RTS/CTS with TXOP sharing) which allows to freely change the remaining bits in the frame control field and to add additional fields to the CTS message. For example, bits B8-B15 are used in the following way:
Use B8 to indicate TXOP sharing (set to 1 if TXOP sharing is used)
Use the remaining bits to include a Partial BSSID of the relay or add a Partial BSSID field to the CTS frame in FIG. 3

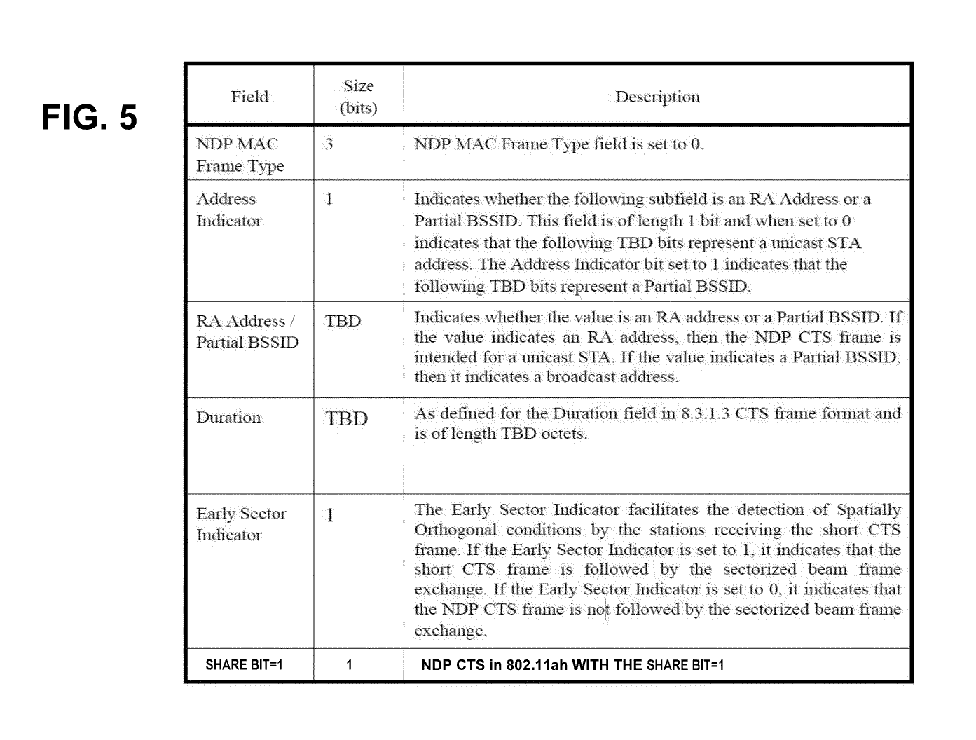

FIG. 5 is an example table describing the fields in the first clear-to-send (CTS1) frame in the IEEE 802.11 ah format, with the addition of the share bit SH=1 that indicates an intention to share the transmission opportunity (TXOP), according to an example embodiment of the invention. In accordance with an example embodiment of the invention, the specification framework document of 802.1 lah specifies in addition to the regular clear-to-send CTS frame an NDP clear-to-send CTS frame with the format illustrated in FIG. 5. In accordance with an example embodiment of the invention, a TXOP sharing bit is added in the NDP clear-to-send CTS frame. The relay STA 2R will set the TXOP sharing bit to 1, sets the Address Indicator bit to 1 and uses the Partial BSSID (known by AP 1). The AP 1 will receive the NDP-clear-to-send CTS frame, check for the TXOP sharing bit and if the Partial BSSID matches with one of its relays. If it matches, the AP will repeat the same NDP clear-to-send CTS frame as sent by the relay STA 2R. Alternatively, the AP can use the RA address of the relay STA 2R.

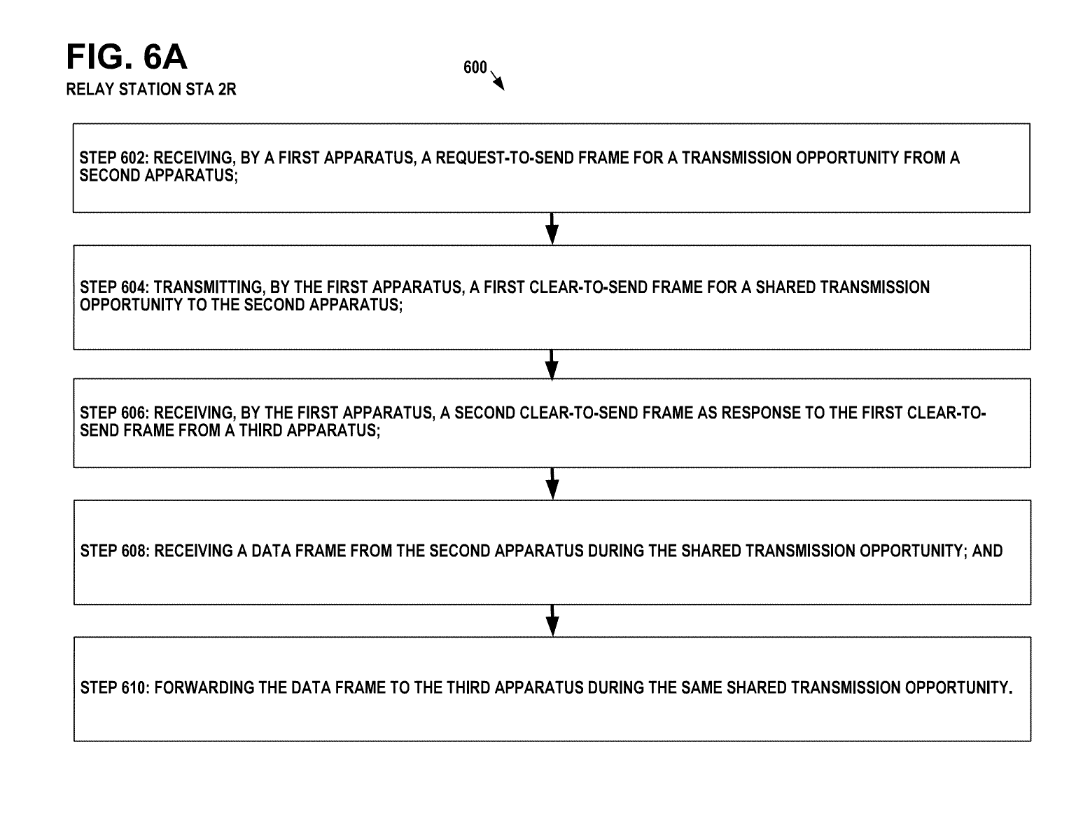

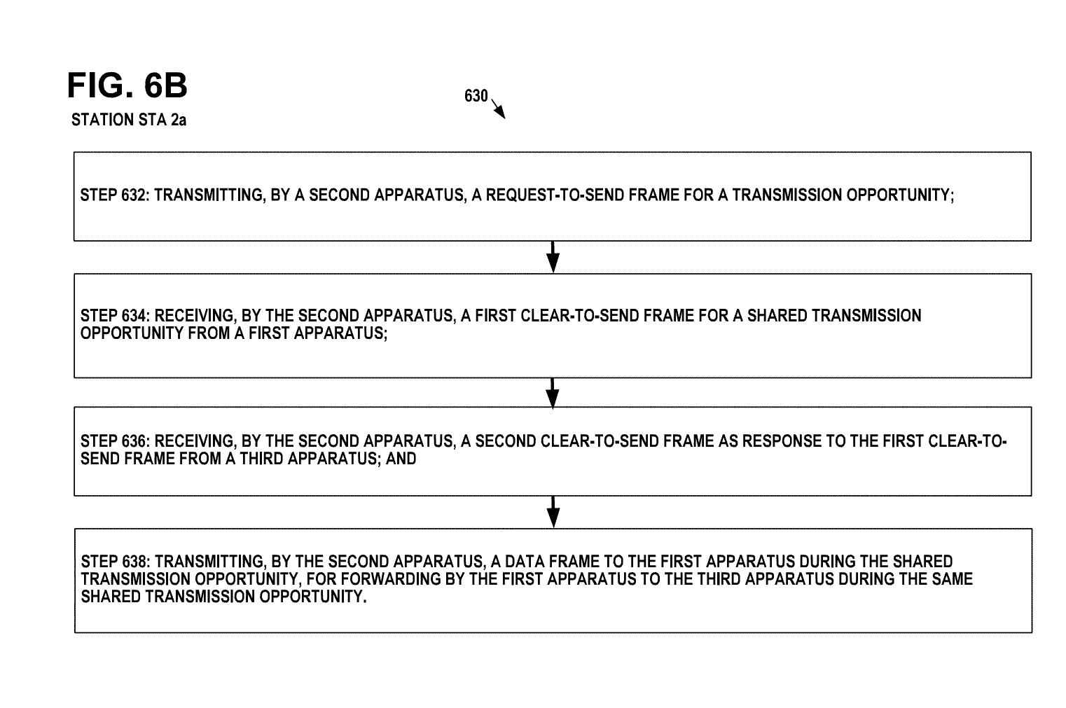

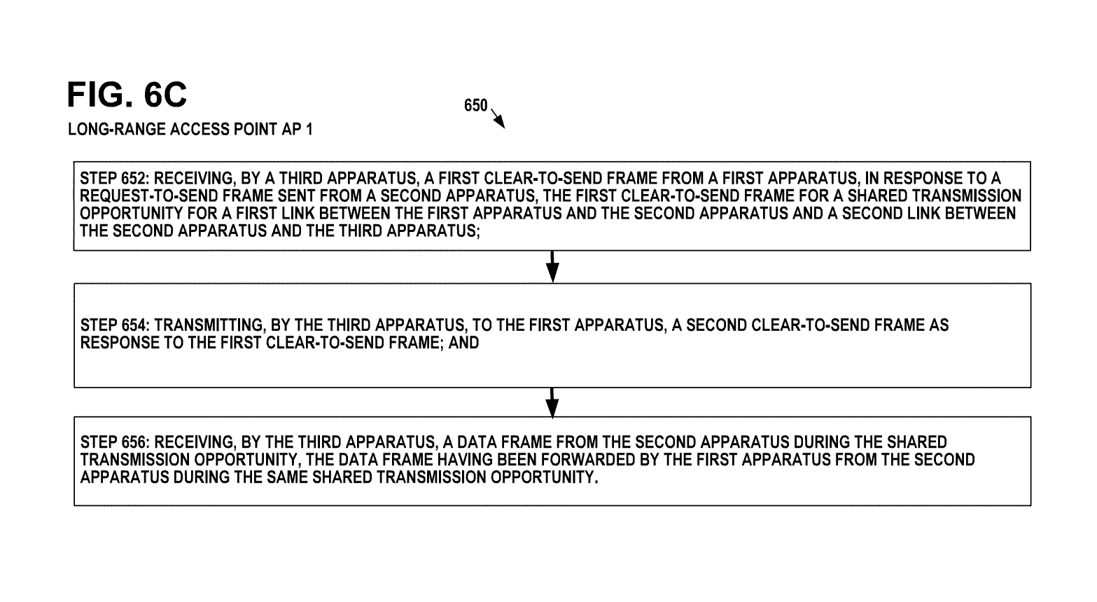

FIG. 6A is an example flow diagram 600 of operational steps in the wireless relay STA 2R, according to an example embodiment of the invention. The steps of the flow diagram represent computer code instructions stored in the RAM and/or ROM memory of the device, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 602: receiving, by a first apparatus, a request-to-send frame for a transmission opportunity from a second apparatus;

Step 604: transmitting, by the first apparatus, a first clear-to-send frame for a shared transmission opportunity to the second apparatus;

Step 606: receiving, by the first apparatus, a second clear-to-send frame as response to the first clear-to-send frame from a third apparatus;

Step 608: receiving a data frame from the second apparatus during the shared transmission opportunity; and

Step 610: forwarding the data frame to the third apparatus during the same shared transmission opportunity.

FIG. 6B is an example flow diagram 630 of operational steps in the originating station STA 2a, according to an example embodiment of the invention. The steps of the flow diagram represent computer code instructions stored in the RAM and/or ROM memory of the device, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 632: transmitting, by a second apparatus, a request-to-send frame for a transmission opportunity;

Step 634: receiving, by the second apparatus, a first clear-to-send frame for a shared transmission opportunity from a first apparatus;

Step 636: receiving, by the second apparatus, a second clear-to-send frame as response to the first clear-to-send frame from a third apparatus; and

Step 638: transmitting, by the second apparatus, a data frame to the first apparatus during the shared transmission opportunity, for forwarding by the first apparatus to the third apparatus during the same shared transmission opportunity.

FIG. 6C is an example flow diagram 650 of operational steps in the long-range access point AP 1, according to an example embodiment of the invention. The steps of the flow diagram represent computer code instructions stored in the RAM and/or ROM memory of the device, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 652: receiving, by a third apparatus, a first clear-to-send frame from a first apparatus, in response to a request-to-send frame sent from a second apparatus, the first clear-to-send frame for a shared transmission opportunity for a first link between the first apparatus and the second apparatus and a second link between the second apparatus and the third apparatus;

Step 654: transmitting, by the third apparatus, to the first apparatus, a second clear-to-send frame as response to the first clear-to-send frame; and

Step 656: receiving, by the third apparatus, a data frame from the second apparatus during the shared transmission opportunity, the data frame having been forwarded by the first apparatus from the second apparatus during the same shared transmission opportunity.

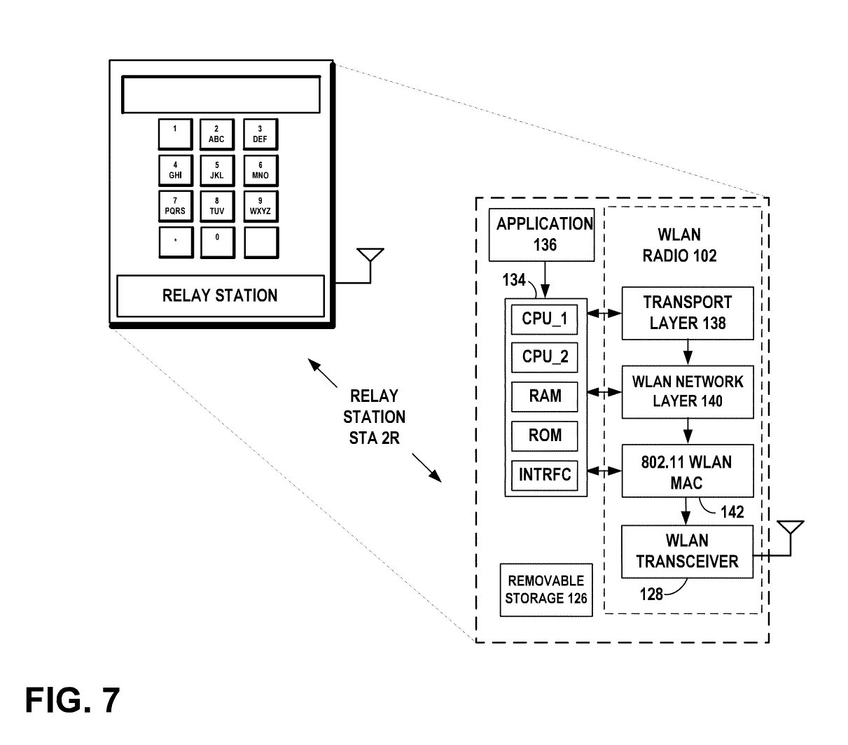

FIG. 7 is an example functional block diagram, illustrating an example wireless relay device STA 2R, according to an example embodiment of the invention. The example wireless relay device STA 2R may include a processor 134 that may include at least one of the following: a dual or multi-core central processing unit CPU_{—}1 and CPU_{—}2, a RAM memory, a ROM memory, and an interface for a keypad, display, and other input/output devices. The example wireless relay device STA 2R may include a WLAN protocol stack, including the IEEE 802.11 MAC 142, which may be based, for example, on the IEEE 802.11ah WLAN standard for communication with the AP 1 over the long range network BSS1. The WLAN protocol stack may also include a network layer 140, a transport layer 138, and an application program 136. In accordance with an embodiment of the invention, the example wireless relay device STA 2R may include a P2P protocol stack, including the Wi-Fi Direct peer-to-peer MAC for communication over Sub-Network 2 with the P2P client stations STA 2a, STA 2b, and STA 2c. The P2P protocol stack may also include a network layer and a transport layer.

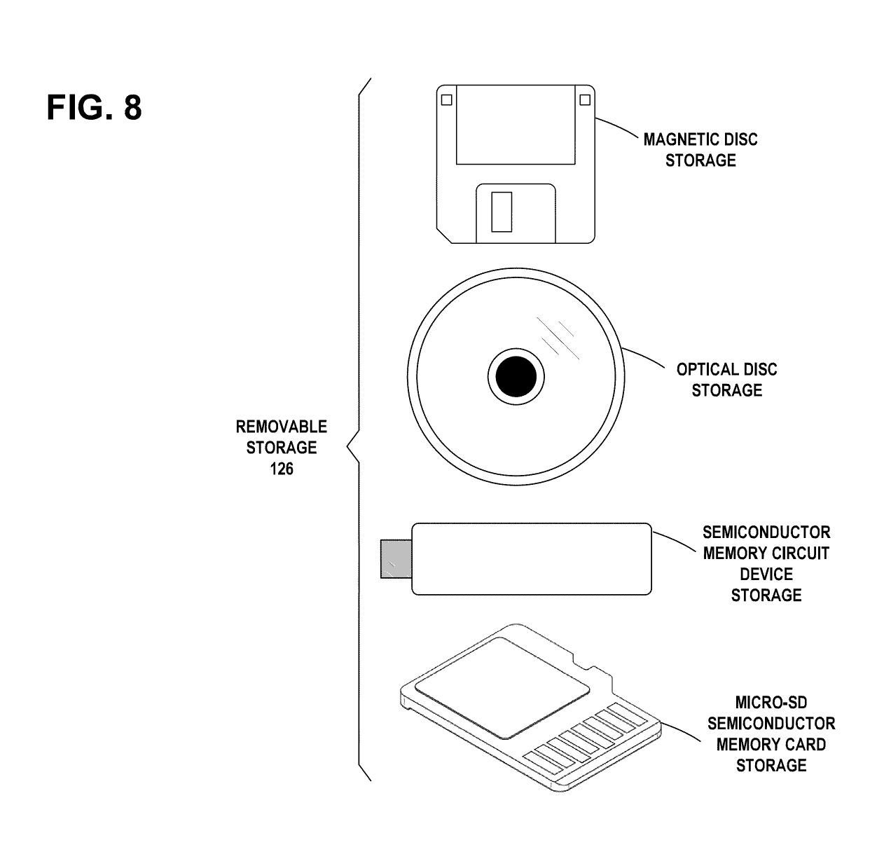

In an example embodiment, the interface circuits in FIG. 7 may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 8, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the originating station STA 2a may have the same or similar components as does the relay station STA 2R shown in FIG. 7.

In an example embodiment of the invention, the long-range access point AP 1 may have the same or similar components as does the relay station STA 2R shown in FIG. 7.

FIG. 8 illustrates an example embodiment of the invention, wherein examples of removable storage media 126 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, wireless networks may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks, as well as short range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the STAs may be, for example, a miniature device such as a key fob, smart card, jewelry, or the like. The STAs may be, for example, a larger device such as a cell phone, smart phone, flip-phone, PDA, graphic pad, or even larger devices such as a laptop computer, an automobile, and the like.

In an example embodiment of the invention, an apparatus comprises:

means for receiving, by a first apparatus, a request-to-send frame for a transmission opportunity from a second apparatus;

means for transmitting, by the first apparatus, a first clear-to-send frame for a shared transmission opportunity to the second apparatus;

means for receiving, by the first apparatus, a second clear-to-send frame as response to the first clear-to-send frame from a third apparatus;

means for receiving a data frame from the second apparatus during the shared transmission opportunity; and

means for forwarding the data frame to the third apparatus during the same shared transmission opportunity.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable non-transitory media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting media include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
receiving, by a first apparatus, a request-to-send frame for a transmission opportunity from a second apparatus;
transmitting, by the first apparatus, a first clear-to-send frame for a shared transmission opportunity to the second apparatus;
receiving, by the first apparatus, a second clear-to-send frame as response to the first clear-to-send frame from a third apparatus;
receiving a data frame from the second apparatus during the shared transmission opportunity; and
forwarding the data frame to the third apparatus during the same shared transmission opportunity.

2. The method of claim 1, further comprising:
wherein a bit in the first clear-to-send frame indicates an intention to share the transmission opportunity.

3. The method of claim 1, further comprising:
wherein the first clear-to-send frame comprises a first duration field value and the second clear-to-send frame comprises a second duration field value that is based on the first duration field value.

4. The method of claim 1, further comprising:
wherein the second clear-to-send frame comprises at least one of a copy of a receiver address in the first clear-to-send frame and at least a portion of a basic service set identifier of the first apparatus.

5. The method of claim 1, further comprising:
wherein the first apparatus and the second apparatus are in a sub-network and the third apparatus is an access point in a basic service set network that is overlapped by the sub-network, and the first apparatus serves as a relay between the second apparatus and the third apparatus.

6. The method of claim 5, further comprising:
wherein the sub-network is at least one of part of the basic service set network that is a long-range IEEE 802.11 ah network and a short-range wireless network that overlaps the basic service set network that is a long-range IEEE 802.11ah network.

7. The method of claim 1, further comprising:
determining by the first apparatus, that the request-to-send frame indicates a proposed transmission opportunity time interval that is not long enough to complete a data transmission to the third apparatus; and
transmitting, by the first apparatus, in response to the determination, the first clear-to-send frame, including an indication of the shared transmission opportunity with a longer time interval needed to forward data from the first apparatus to the third apparatus.

8. An apparatus, comprising:
at least one processor;
at least one memory including computer program code;
the at least one memory and the computer program code configured to, with the at least one processor, cause the apparatus at least to:
receive a request-to-send frame for a transmission opportunity from a second apparatus;
transmit a first clear-to-send frame for a shared transmission opportunity to the second apparatus;
receive a second clear-to-send frame as response to the first clear-to-send frame from a third apparatus;
receive a data frame from the second apparatus during the shared transmission opportunity; and
forward the data frame to the third apparatus during the same shared transmission opportunity.

9. The apparatus of claim 8, further comprising:
wherein a bit in the first clear-to-send frame indicates an intention to share the transmission opportunity.

10. The apparatus of claim 8, further comprising:
wherein the first clear-to-send frame comprises a first duration field value and the second clear-to-send frame comprises a second duration field value that is based on the first duration field value.

11. The apparatus of claim 8, further comprising:
wherein the second clear-to-send frame comprises at least one of a copy of a receiver address in the first clear-to-send frame and at least a portion of a basic service set identifier of the apparatus.

12. The apparatus of claim 8, further comprising:
wherein the apparatus and the second apparatus are in a sub-network and the third apparatus is an access point in a basic service set network that is overlapped by the sub-network, and the apparatus serves as a relay between the second apparatus and the third apparatus.

13. The apparatus of claim 12, further comprising:
wherein the sub-network is at least one of part of the basic service set network that is a long-range IEEE 802.11 ah network and a short-range wireless network that overlaps the basic service set network that is a long-range IEEE 802.11ah network.

14. The apparatus of claim 8, further comprising:
the at least one memory and the computer program code configured to, with the at least one processor, cause the apparatus at least to:
determine that the request-to-send frame indicates a proposed transmission opportunity time interval that is not long enough to complete a data transmission to the third apparatus; and
transmit, in response to the determination, the first clear-to-send frame, including an indication of the shared transmission opportunity with a longer time interval needed to forward data from the first apparatus to the third apparatus.

15. A computer program product comprising computer executable program code recorded on a computer readable, non-transitory storage medium, the computer executable program code comprising:
code for receiving, by a first apparatus, a request-to-send frame for a transmission opportunity from a second apparatus;
code for transmitting, by the first apparatus, a first clear-to-send frame for a shared transmission opportunity to the second apparatus;
code for receiving, by the first apparatus, a second clear-to-send frame as response to the first clear-to-send frame from a third apparatus;
code for receiving a data frame from the second apparatus during the shared transmission opportunity; and
code for forwarding the data frame to the third apparatus during the same shared transmission opportunity.

16. The computer program product of claim 15, further comprising:
wherein a bit in the first clear-to-send frame indicates an intention to share the transmission opportunity.

17. The computer program product of claim 15, further comprising:
wherein the first clear-to-send frame comprises a first duration field value and the second clear-to-send frame comprises a second duration field value that is based on the first duration field value.

18. A method, comprising:
transmitting, by a second apparatus, a request-to-send frame for a transmission opportunity;
receiving, by the second apparatus, a first clear-to-send frame for a shared transmission opportunity from a first apparatus;
receiving, by the second apparatus, a second clear-to-send frame as response to the first clear-to-send frame from a third apparatus; and
transmitting, by the second apparatus, a data frame to the first apparatus during the shared transmission opportunity, for forwarding by the first apparatus to the third apparatus during the same shared transmission opportunity.

19. An apparatus, comprising:
at least one processor;
at least one memory including computer program code;
the at least one memory and the computer program code configured to, with the at least one processor, cause the apparatus at least to:
transmit a request-to-send frame for a transmission opportunity;
receive a first clear-to-send frame for a shared transmission opportunity from a first apparatus;
receive a second clear-to-send frame as response to the first clear-to-send frame from a third apparatus; and
transmit a data frame to the first apparatus during the shared transmission opportunity, for forwarding by the first apparatus to the third apparatus during the same shared transmission opportunity.

20. A method, comprising:
receiving, by a third apparatus, a first clear-to-send frame from a first apparatus, in response to a request-to-send frame sent from a second apparatus, the first clear-to-send frame for a shared transmission opportunity for a first link between the first apparatus and the second apparatus and a second link between the second apparatus and the third apparatus;
transmitting, by the third apparatus, to the first apparatus, a second clear-to-send frame as response to the first clear-to-send frame; and
receiving, by the third apparatus, a data frame from the second apparatus during the shared transmission opportunity, the data frame having been forwarded by the first apparatus from the second apparatus during the same shared transmission opportunity.

21. An apparatus, comprising:
at least one processor;
at least one memory including computer program code;
the at least one memory and the computer program code configured to, with the at least one processor, cause the apparatus at least to:
receive a first clear-to-send frame from a first apparatus, in response to a request-to-send frame sent from a second apparatus, the first clear-to-send frame for a shared transmission opportunity for a first link between the first apparatus and the second apparatus and a second link between the second apparatus and the apparatus;
transmit to the first apparatus, a second clear-to-send frame as response to the first clear-to-send frame; and
receive a data frame from the second apparatus during the shared transmission opportunity, the data frame having been forwarded by the first apparatus from the second apparatus during the same shared transmission opportunity.
